(19) United States
(12) Patent Application Publication
(10) Pub. No.: US 2007/0152780 A1
(43) Pub. Date: Jul. 5, 2007

(54) MINI MULTILAYER BAND-PASS FILTER HAVING A BALANCED TO UNBALANCED SIGNAL TRANSFORMING CAPABILITY

(75) Inventors: Ping-Hsiao LIAO, Taichung City (TW); Keng-Yi HUANG, Puzih City (TW); Jin-Lung TSAI, Chiayi City (TW)

Correspondence Address: PATENTTM.US, P. O. BOX 82788, PORTLAND, OR, 97282-0788, US

(73) Assignee: WALSIN TECHNOLOGY CORPORATION, Taipei (TW)

(21) Appl. No.: 11/614,028

(22) Filed: Dec. 20, 2006

(30) Foreign Application Priority Data
Dec. 29, 2005 (TW) 094222964

(51) Int. Cl. H01P 1/203; H01P 5/10

(52) U.S. Cl. 333/204; 333/26

(57) ABSTRACT

The mini multilayer band-pass filter for balanced to unbalanced signal transformation includes a multilayer substrate and multiple coupling transmission lines. The multiple coupling transmission lines can be formed on one layer of the multilayer substrate or respectively formed on the corresponding layers. Every two of the coupling transmission lines are coupled in order to form a band-pass filter. The first coupling transmission line is configured with an unbalanced input terminal and the last coupling transmission line is configured with two balanced output terminals. With this configuration, a conventional balanced to unbalanced transformer is not necessary to be configured between the band-pass filter and the post circuit. Hence a volume of the circuit can be reduced, and also a loss of the signal transformation can be reduced. Further, a noise of a coupling effect generated between the filter and the balanced to unbalanced transformer can be avoided.

### BACKGROUND OF THE INVENTION

1. Field of the Invention

The invention relates in general to a band-pass filter; and more particularly to a mini multilayer band-pass filter having a balanced to unbalanced signal transforming capability.

2. Description of the Related Art

A conventional band-pass filter can be configured in front of an amplifier to filter an input signal and then to send the filtered signal to the amplifier. The conventional band-pass filter usually has one input terminal and one output terminal, which inputs and outputs an unbalanced signal. When the band-pass filter is coupled to the amplifier which includes a balanced input terminal, such as a differential amplifier, a balun of a type of transformer is required to be added between the band-pass filter and the amplifier. The balun is used to convert an unbalanced signal to a balanced one or vice versa. With the balun, the outputted unbalanced signal of the band-pass filter can be transformed to the balanced signal to be sent to the amplifier.

However, with the above-described configuration of two separate components of the band-pass filter and the balun, not only a circuit volume increases, but also a signal loss becomes significant for the signal has to go though the band-pass filter and the balun. Besides, a coupling effect occurs between the band-pass filter and the balun, so as to interfere with each other and further make electric appliance property become hard to be tuned. Therefore the conventional design of the band-pass filter still needs to be further improved.

### SUMMARY OF THE INVENTION

The present invention provides a band-pass filter that includes a capability of outputting a balanced signal without further coupling with a balanced to unbalanced transformer

In order to achieve the above objective, a main technique of the present invention is to make the band-pass filter formed by a multilayer substrate. The multilayer substrate includes multiple coupling transmission lines. Every two of the coupling transmission lines are coupled in order. The first coupling transmission line is configured with an unbalanced input terminal and the last coupling transmission line is configured with two balanced output terminals. With this configuration, a conventional balanced to unbalanced transformer is not necessary to be configured between the band-pass filter and the post circuit. Hence a volume of the circuit can be reduced, and also a loss of the signal transformation can be reduced. Further, a noise of a coupling effect generated between the filter and the balanced to unbalanced transformer can be avoided.

Further, both ends of the coupling transmission line can be respectively connected to the ground via a ground capacitance. Both ends of every two of the coupling transmission lines are coupled together via the coupling capacitance.

Moreover, one proper position of the coupling transmission line configured with the balanced output terminal can be further connected to the ground via a ground capacitance. The coupling capacitance is made up by a metal layer on the two adjacent substrates.

An inductance or a transmission line is serial-connected between the balanced output terminal and the coupling transmission line, so as to tune an impedance matching between the band-pass filter of the present invention and the post circuit. The other end of the coupling transmission line with corresponding to the unbalanced input terminal can be directly connected to the ground. The inductance is made up by a spiral metal circuit, which is formed between the coupling transmission line and the balanced output terminal and the adjacent substrates.

Other objectives, advantages and novel features of the invention will become more apparent from the following detailed description when taken in conjunction with the accompanying drawings.

### BRIEF DESCRIPTION OF THE DRAWINGS

FIG. 1 is an equivalent diagram of a first embodiment of the circuit layout of band pass filter in accordance with the present invention.

FIG. 2 is a perspective view of a first physical multilayer structure implemented by the first embodiment of the band pass filter in accordance with the present invention.

FIG. 3 is an exploded perspective view of a second physical multilayer structure implemented by the first embodiment of the band pass filter in accordance with the present invention.

FIG. 4 is an equivalent diagram of a second embodiment of the circuit layout of band pass filter in accordance with the present invention.

FIG. 5 is an equivalent diagram of a third embodiment of the circuit layout of band pass filter in accordance with the present invention.

FIG. 6 is an exploded perspective view of a physical multilayer structure implemented by the third embodiment of the band pass filter in accordance with the present invention.

FIG. 7 is an equivalent diagram of a fourth embodiment of the circuit layout of band pass filter in accordance with the present invention.

FIG. 8 is an equivalent diagram of a fifth embodiment of the circuit layout of band pass filter in accordance with the present invention.

FIG. 9 is an equivalent diagram of a sixth embodiment of the circuit layout of band pass filter in accordance with the present invention.

FIG. 10 is an exploded perspective view of a physical multilayer structure implemented by the sixth embodiment of the band pass filter in accordance with the present invention.

FIG. 11 is an equivalent diagram of a seventh embodiment of the circuit layout of band pass filter in accordance with the present invention.

### DETAILED DESCRIPTION OF THE INVENTION

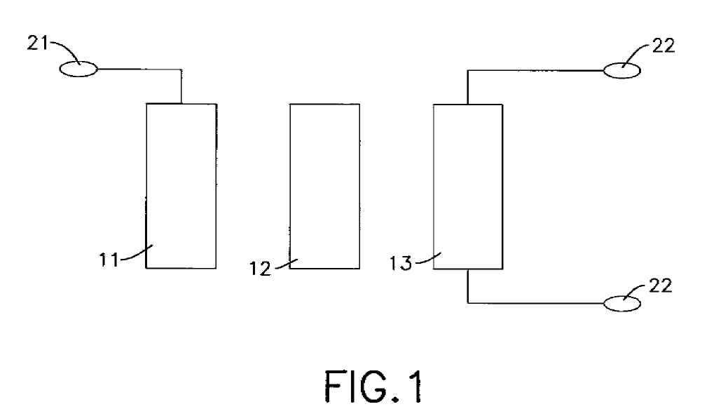

With reference to FIG. 1, a first example of a mini multilayer band-pass filter having a balanced to unbalanced signal transforming capability of the present invention mainly includes a first coupling transmission line (11), a second coupling transmission line (12) and a third coupling transmission line (13). The first and the second coupling transmission lines (11) and (12) are correspondingly coupled together with an appropriate distance, and also the second and the third coupling transmission lines (12) and (13) are correspondingly coupled together with the appropriate distance. One end of the first coupling transmission line (11) is configured with an unbalanced input terminal (21) and the other end is a free end. Both ends of the third coupling transmission line (13) are respectively configured with a balanced output terminal (22).

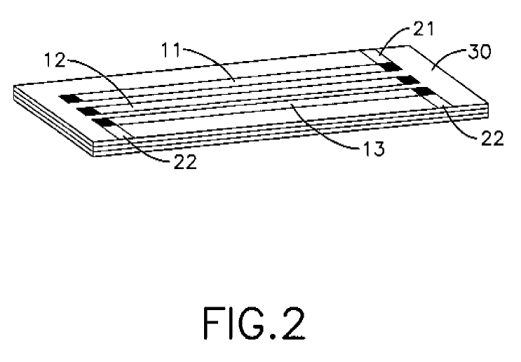

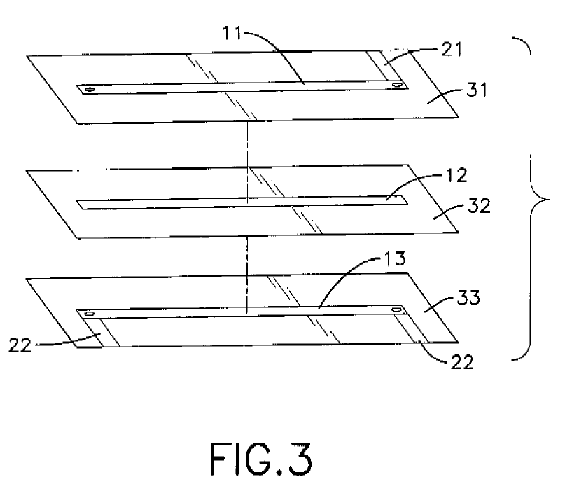

With reference to FIG. 2, a first physical multilayer structure implemented by the first embodiment of the present invention shows that the coupling transmission lines (11), (12) and (13) can be configured on one layer of the multilayer substrate (30), so as to be coupled together in a horizontal direction. Moreover, a second physical multilayer structure implemented by the first embodiment of the present invention as shown in FIG. 3 illustrates that the coupling transmission lines (11, 12, 13) can be respectively configured on three layers (31, 32, 33), so as to be coupled together in a vertical direction.

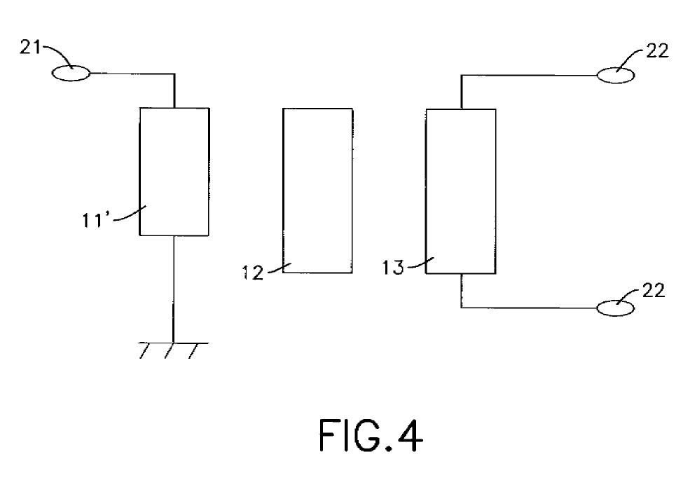

Further, a second embodiment of the present invention is shown in FIG. 4. The difference between the first and the second examples in the FIG. 1 and FIG. 4 is that the free end of the first coupling transmission line (11′) with corresponding to the unbalanced input terminal (21) is connected to the ground. To have a one-fourth wavelength effect of the transmission line, a length of the transmission line can be reduced. Hence a length of the first coupling transmission line (11′) is shorter than a length of the first coupling transmission line (11) of the first embodiment of the present invention.

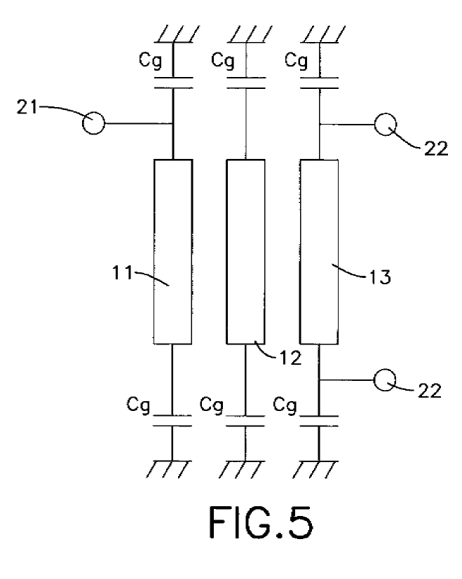

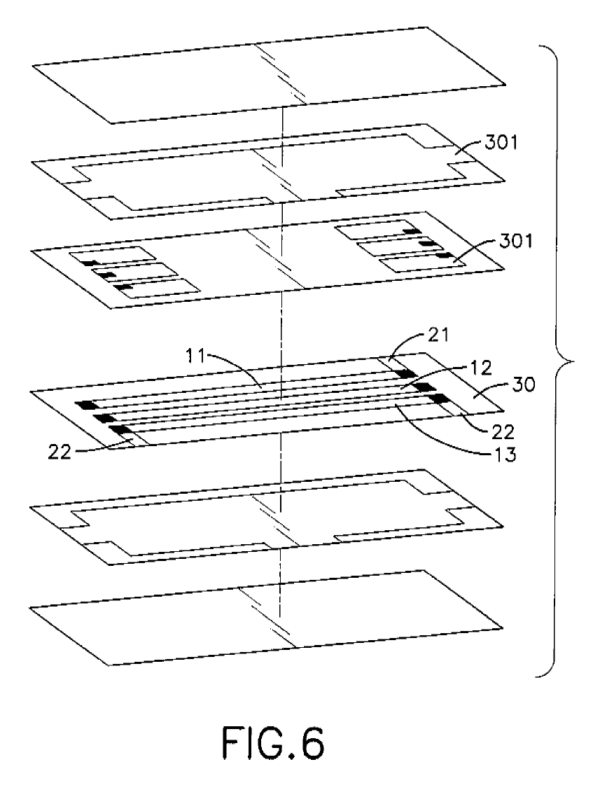

With reference to FIG. 5, a third embodiment of the present invention is approximately similar to the first embodiment of the present invention of the FIG. 1. A main difference of the third embodiment is that both ends of the first to third coupling transmission lines (11, 12, and 13) are respectively connected to the ground via a ground capacitance (Cg). With the ground capacitance (Cg), an optimal matching property of the band-pass filter of the present invention can be tuned according to different operation frequency band or different post circuit. The ground capacitance (Cg) is made up by a metal layer (301) on the adjacent substrates (30) as shown in FIG. 6.

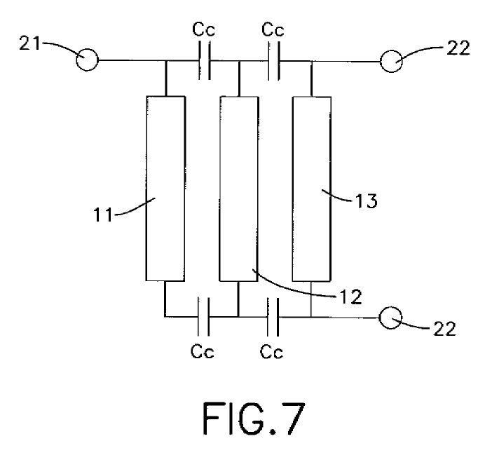

With reference to FIG. 7, a fourth example of a circuit diagram of the present invention is approximately similar to the first example of the present invention of the FIG. 1. A main difference of the fourth example is that both ends of every two of the coupling transmission lines (11, 12 and 13) are coupled together via a coupling capacitance (Cc). With the coupling capacitance (Cc), the band-pass filter of the present invention can be tuned to achieve the optimal matching property.

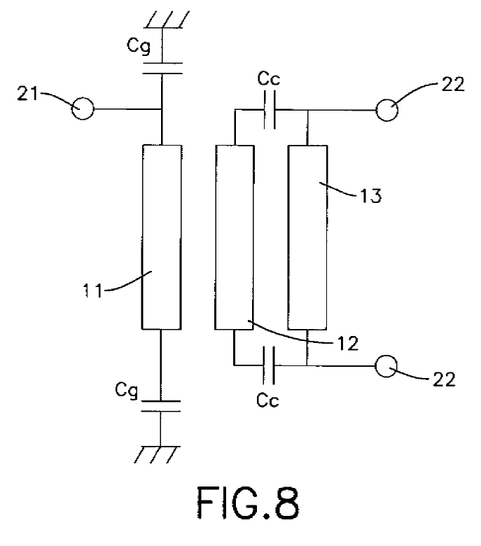

Further, a fifth example of a circuit diagram of the present invention as shown in FIG. 8 is approximately similar to the first example of the present invention of the FIG. 1. A main difference of the fifth example is that both ends of the first coupling transmission line (11) are respectively connected to the ground via a ground capacitance (Cg), and both ends of the second and the third coupling transmission lines (12, 13) are coupled together via a coupling capacitance (Cc). With the ground capacitance (Cg) and the coupling capacitance (Cc), the band-pass filter of the present invention can be tuned to achieve the optimal matching property.

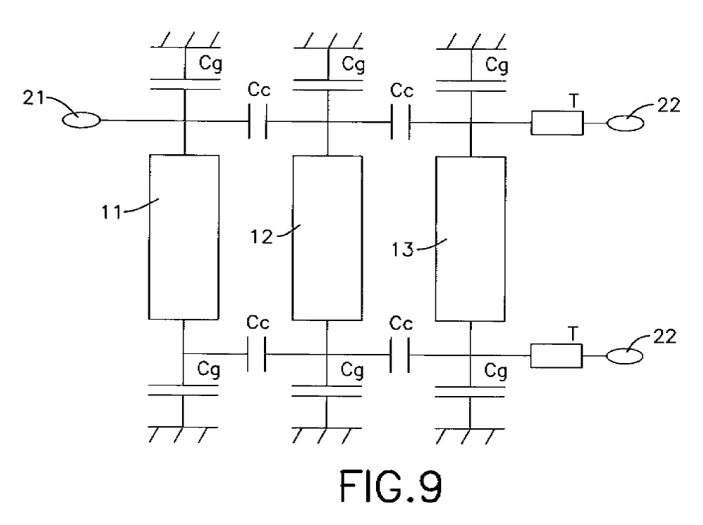

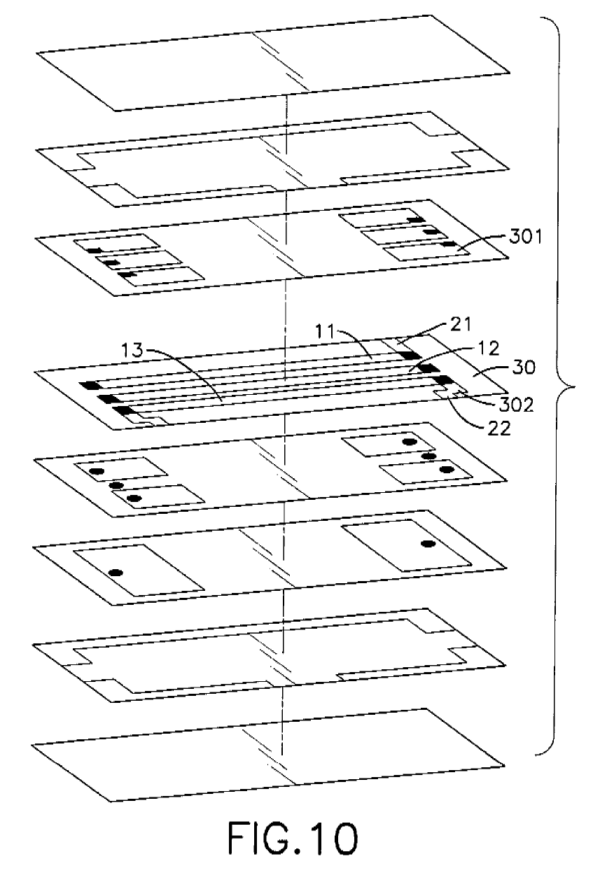

Moreover, a sixth example of a circuit diagram of the present invention as shown in FIG. 9 is mainly a combination of the third embodiment and the fourth example of the present invention. Both ends of the coupling transmission lines (11, 12, 13) are respectively connected to the ground via a ground capacitance (Cg), and both ends of every two of the coupling transmission lines (11, 12 13) are coupled together via a coupling capacitance (Cc). A significant difference of the sixth embodiment is that two transmission line (T) are respectively serial-connected between the balanced output terminal (22) and the third coupling transmission line (13), so as to tune an impedance matching between the band-pass filter of the present invention and the post circuit. The transmission line (T) is made up by a metal circuit (302) between the third coupling transmission line (13) and the balanced output terminal (22) as shown in FIG. 10.

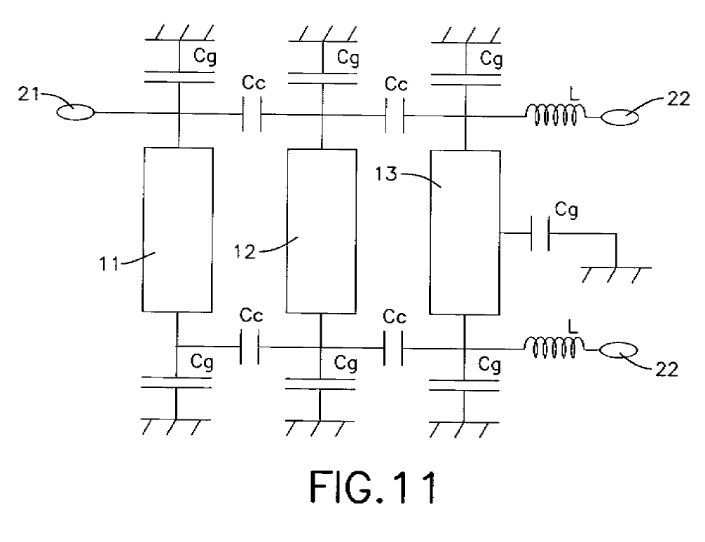

In addition, with reference to FIG. 11, a seventh embodiment of a circuit diagram of the present invention is approximately similar to the sixth embodiment of the present invention of the FIG. 9. A significant difference of the seventh embodiment is that the coupling transmission line configured with the balanced output terminal can be directly connected to the ground. For example, one proper position of the third coupling transmission line (13) is connected to the ground through a ground capacitance (Cg), so as to provide a DC (direct current) bias path for the post circuit. Two inductance (L) are respectively serial-connected between the balanced output terminal (22) and the third coupling transmission line (13). The inductance (L) is made up by a spiral metal circuit (not shown in the diagram), which is formed between the third coupling transmission line (13) and the balanced output terminal (22) and the adjacent substrates.

It can be clearly understood from the above description that the coupling transmission lines of the present invention include not only the effect of band-pass filter but also the ability of transforming the unbalanced input signal to balanced output signal. In this way, the conventional balanced to unbalanced transformer is not necessary to be configured between the band-pass filter and the post circuit. Hence a volume of the circuit can be reduced, and also a loss of the signal transformation can be reduced. Further, a noise of a coupling effect generated between the filter and the balanced to unbalanced transformer can be avoided. Hence an electric appliance property between the band-pass filter and the balanced to unbalanced transformer is easy to be tuned. Therefore, the mini multilayer band-pass filter for balanced to unbalanced signal transformation of the present invention is an improved and practical device in comparison with the conventional band-pass filter, so as to include features of good utility and unobviousness to meet the requirements of a patent.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A mini multilayer band-pass filter having a balanced to unbalanced signal transforming capability comprising
a multilayer substrate having multiple layers; and
multiple coupling transmission lines respectively formed on corresponding layer of the multilayer substrate; wherein every two of the multiple coupling transmission lines are coupled in order; wherein a first coupling transmission line of the multiple coupling transmission lines is configured with an unbalanced input terminal and a last coupling transmission line of the multiple coupling transmission lines is configured with two balanced output terminals.

2. A mini multilayer band-pass filter having a balanced to unbalanced signal transforming capability comprising
a multilayer substrate having multiple layers; and
multiple coupling transmission lines formed on one layer of the multilayer substrate; wherein every two of the multiple coupling transmission lines are coupled in order; wherein a first coupling transmission line of the multiple coupling transmission lines is configured with an unbalanced input terminal and a last coupling transmission line of the multiple coupling transmission lines is configured with two balanced output terminals.

3. The mini multilayer band-pass filter as claimed in one of claims 1, wherein both ends of the coupling transmission line can be connected to the ground via a ground capacitance.

4. The mini multilayer band-pass filter as claimed in one of claims 2, wherein both ends of the coupling transmission line can be connected to the ground via a ground capacitance.

5. The mini multilayer band-pass filter as claimed in one of claims 1, wherein both ends of every two of the coupling transmission lines are coupled together via a coupling capacitance.

6. The mini multilayer band-pass filter as claimed in one of claims 2, wherein both ends of every two of the coupling transmission lines are coupled together via a coupling capacitance.

7. The mini multilayer band-pass filter as claimed in claim 3, wherein both ends of every two of the coupling transmission lines are coupled together via a coupling capacitance.

8. The mini multilayer band-pass filter as claimed in one of claims 1, wherein the coupling transmission line configured with the balanced output terminal is connected to the ground via a node of the coupling transmission line or via a ground capacitance.

9. The mini multilayer band-pass filter as claimed in one of claims 2, wherein the coupling transmission line configured with the balanced output terminal is connected to the ground via a node of the coupling transmission line or via a ground capacitance.

10. The mini multilayer band-pass filter as claimed in one of claims 1, wherein a transmission line is serial-connected between the balanced output terminal and the coupling transmission line configured with the balanced output terminal.

11. The mini multilayer band-pass filter as claimed in one of claims 1, wherein an inductance is serial-connected between the balanced output terminal and the coupling transmission line.

12. The mini multilayer band-pass filter as claimed in one of claims 2, wherein an inductance is serial-connected between the balanced output terminal and the coupling transmission line.

13. The mini multilayer band-pass filter as claimed in one of claims 1, wherein the other end of the coupling transmission line with corresponding to the unbalanced input terminal is directly connected to the ground.

14. The mini multilayer band-pass filter as claimed in one of claims 2, wherein the other end of the coupling transmission line with corresponding to the unbalanced input terminal is directly connected to the ground.

15. The mini multilayer band-pass filter as claimed in claim 10, wherein the transmission line is made up by a metal circuit between the balanced output terminal on the multilayer substrate the adjacent coupling transmission line.

16. The mini multilayer band-pass filter as claimed in claim 11, wherein the inductance is made up by a spiral metal circuit, which is formed between the balanced output terminal on the multilayer substrate and the adjacent coupling transmission line and the adjacent substrates.

17. The mini multilayer band-pass filter as claimed in claim 3, wherein the capacitance is made up by a metal layer on the two adjacent layers.

18. The mini multilayer band-pass filter as claimed in claim 5, wherein the capacitance is made up by a metal layer on the two adjacent layers.

19. The mini multilayer band-pass filter as claimed in claim 8, wherein the capacitance is made up by a metal layer on the two adjacent substrates.

20. The mini multilayer band-pass filter as claimed in claim 9, wherein the capacitance is made up by a metal layer on the two adjacent substrates.
